(19) United States
(12) Patent Application Publication
(10) Pub. No.: US 2017/0205026 A1
(43) Pub. Date: Jul. 20, 2017

(54) MONITOR LIFT STATION

(71) Applicants: Phillip Cousins, Lebanon, OH (US); Ruth Ann Cousins, Lebanon, OH (US)

(72) Inventors: Phillip Cousins, Lebanon, OH (US); Ruth Ann Cousins, Lebanon, OH (US)

(21) Appl. No.: 15/001,651

(22) Filed: Jan. 20, 2016

(51) Int. Cl. F16M 11/38; F16M 11/42

(52) U.S. Cl. CPC F16M 11/38; F16M 11/42

(57) ABSTRACT

A monitor lift station for an air traffic video monitor that includes: a base; a upper base, where the upper base is adapted to vertically lift from the base and said upper base is attached to some scissor lifts. The scissor lifts enable the vertical movement of the upper base. The lift station also includes a monitor support, where the monitor support supports a monitor therein; and a height control lever on side of the monitor support. The control lever controls the vertical height of the upper base. Preferably, a work ledge extends from the monitor support and a set of wheels support the base to enable movement thereof.

### BACKGROUND OF THE INVENTION

Field of Invention

The present invention relates to a monitor lift station used for an air traffic control video monitor.

Description of Related Art

Air traffic control stations are used by air traffic controllers to monitor air traffic through visual displays on the monitors. The monitors typically are placed on a desk or similar workstation and an air traffic controller sits behind the monitors for hours reviewing air traffic and related communications. One drawback to this workstation configuration is that the air traffic controller must remain in a seated position throughout their work shift. Such prolonged seating takes a toll over an individual's body over a period of time. An individual may begin to suffer back problems, heart ailments, increased stress and loss of concentration while in a seated position behind a video monitor. As a result, it would be advantageous to have a system or a workstation that allows for the vertical movement of the monitor so that the air traffic controller can stand while working therefore alleviating some of the stress of continuous sitting over a period of time.

### SUMMARY OF THE INVENTION

The present invention relates to a monitor lift station for an air traffic video monitor that includes: a base; a upper base, where the upper base is adapted to vertically lift from the base and said upper base is attached to some scissor lifts, where the scissor lifts enable the vertical movement of the upper base; a monitor support, where the monitor support supports a monitor therein; and a height control lever on side of the monitor support, where the control lever controls the vertical height of the upper base. Preferably, a work ledge extends from the monitor support and a set of wheels support the base to enable movement thereof.

### BRIEF DESCRIPTION OF DRAWINGS

FIG. 1 depicts a base used with a monitor lift station according to the present invention.

FIG. 2 depicts the monitor lift station with a monitor in an elevated position.

FIG. 3 depicts a side view of the monitor on the monitor support.

### DETAIL DESCRIPTION

The present invention relates to a monitor lift station for air traffic video monitor. This monitor lift station includes a base, where the base includes an upper base. The upper base is adapted to vertically lift from the base through the use of a scissor lift within the base assembly. The scissor lift may be activated through the use of a height lever that accommodates vertical movement control of the lift station. Further components of the lift station include a monitor support that sits on top of an upper base that receives and supports the video monitor. The height lever may be attached to this monitor support along with a work ledge that extends horizontally from the monitor support. This configuration enables an air traffic controller to control the vertical height of the monitor while working. This vertical control enables the air traffic controller to lift the station to the appropriate height as desired during their workday. Such a station could help alleviate some of the stress of sitting several hours and provide relief for the air traffic controller. Another feature of the present invention relates to a set of wheels that may be attached to the base. The wheels allow for the movement of the monitor lift station as desired.

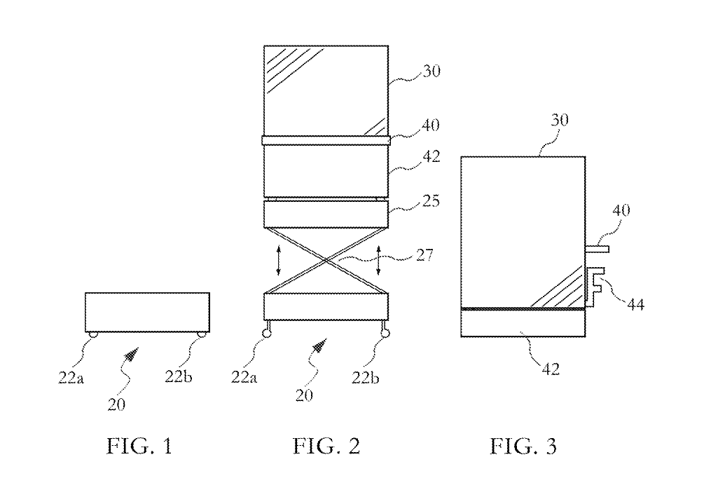

In reference to FIG. 1, a Base 20 in accordance with the present events is depicted. The Base 20 may include a set of wheels 20a, 22b. The base 20 is used to support and lift a air traffic control video monitor as shown in FIG. 2. FIG. 2 shows the complete base assembly that includes a Scissor Lift 27 and an Upper Base 25. The upper base 25 supports a Monitor Support 42 that allows for the insertion of a Air Traffic Control Video Monitor 30. FIG. 2 depicts the Monitor 30 in an elevated position using the Scissor Lift 27. The Scissor Lift 27 may be activated and controlled through a Height Lever 44 as shown in FIG. 3. This height lever 44 allows the user to vary the vertical position of the Monitor 30. One additional feature of the Monitor Support 42 is a Ledge 40 that extends horizontally from the Support 42. The Ledge 40 is more clearly shown in FIG. 3, where the Ledge 40 lies above the Height Lever 44. The resulting monitor lift station therefore provides a convenient and effective means to assist the air traffic controller in adjusting the height of the air traffic control video monitor. The instant invention has been shown and described in what it considers to be the most practical and preferred embodiments. It is recognized, however, that departures may be made there from within the scope of the invention and that obvious modifications will occur to a person skilled in the art.

1. A monitor lift station for an air traffic video monitor comprising:
a. a base;
b. a upper base, where the upper base is adapted to vertically lift from the base and said upper base is attached to some scissor lifts, where the scissor lifts enable the vertical movement of the upper base;
c. a monitor support, where the monitor support supports a monitor therein; and
d. a height control lever on side of the monitor support, where the control lever controls the vertical height of the upper base.

2. The monitor lift station according to claim 1, where a work ledge extends from the monitor support.

3. The monitor lift station according to claim 1, further including a set of wheels to support the base and enable movement thereof.
